(19) United States
(12) Patent Application Publication
(10) Pub. No.: US 2001/0036543 A1
(43) Pub. Date: Nov. 1, 2001

(54) Plastic sheet product offering matte appearance and method of preparation

(76) Inventors: Darrell L. Sparks, Kennebunk, ME (US); Grant B. LaFontaine, Trumbull, CT (US); Jennifer A. Hay, Vernon, NJ (US); Robert E. Smith, Shapleigh, ME (US)

Correspondence Address: KLAUBER & JACKSON, 411 Hackensack Avenue, Hackensack, NJ, 07601, US

(21) Appl. No.: 09/817,788

(22) Filed: Mar. 26, 2001

Related U.S. Application Data
(60) Provisional application No. 60/192,057, filed on Mar. 24, 2000.

(51) Int. Cl. B32B 7/02; B32B 27/30

(52) U.S. Cl. 428/215; 428/327; 428/328; 428/329; 428/330; 428/331; 428/520; 428/522

(57) ABSTRACT

A plastic sheet product having a matte finish comprises a core layer of a thermoplastic polymer and at least one layer of a capstock composition which overlies, and is bonded to, at least one face of the core layer. The capstock composition comprises the same or different thermoplastic polymer and contains a plurality of discrete particles immiscible with and dispersed in the thermoplastic polymer of the capstock composition. The sheet product may be prepared by the co-extrusion of the thermoplastic polymer and the capstock composition, and in a particular embodiment, such co-extrusion may be conducted by means of a feedblock. In a particular embodiment, the thermoplastic polymer of the core layer and that of the capstock composition may be the same, such as in the instance of a methylmethacrylate-methylacrylate copolymer. Sheet products prepared in accordance with the invention exhibit improved post-processability and ease of surface maintenance, and may be fabricated into a variety of products including light diffusers, projection screens, and the like.

### RELATED CASES

The present application is based upon Provisional Application Ser. No. 60/192,057 filed on Mar. 24, 2000.

### BACKGROUND OF THE INVENTION

1. Field of the Invention

The invention relates to a plastic sheet product exhibiting a matte appearance which comprises a core layer and at least one layer of a capstock composition which overlies and is bonded to at least one face of the core layer, where the capstock composition contains particulate inclusions that yield the desired appearance and that emulates frosted glass.

2. Description of Related Art

It is well known that plastic sheets with a matte finish can be manufactured using textured or embossing calendar rolls. However, such technology has several disadvantages such as frequent replacement of the rolls, limited predictability and consequent uniformity of the textural designs of the sheets produced, loss of the texture if the sheet is thermoformed, and the like.

It is also known to prepare a translucent screen comprising a dispersion of a transparent material in a matrix material in which the refractive index of the transparent material differs slightly from that of the matrix material—see U.S. Pat. No. 2,287,556 and published European Patent Application 0 464 499 A2. It is additionally known to coextrude a matrix layer and one or two layers of a capstock composition containing miscible particles of an impact modifier—see U.S. Pat. No. 5,318,737.

Among the shortcomings of the prior art, the sheet materials presently available offer inconsistencies in appearance and difficulty in preparation, as there are often unacceptable variations in the thickness of the matte layer. Also, in the instance where the finish is achieved by surface texturization, the products are more difficult to maintain and clean.

None of the known technology effectively addresses the shortcomings of the prior art with respect to the preparation and resultant quality of the matte appearance plastic sheeting, and it is toward the preparation of products that do not suffer from these shortcomings that the present invention is directed.

### SUMMARY OF THE INVENTION

It has now been found that it is possible to inexpensively prepare a plastic sheet product that offers a matte appearance without the aforementioned drawbacks, which sheet product comprises a core layer of a thermoplastic polymer and at least one layer of a capstock composition which provides the matte appearance to the sheet product, and that overlies and is bonded to at least one face of the core layer. The capstock composition comprises a thermoplastic polymer which may be the same or different from the thermoplastic polymer employed for the core layer and will contain a plurality of discrete particles immiscible with, and dispersed in, the capstock thermoplastic polymer. The refractive index of the particles will differ from that of the capstock thermoplastic polymer.

The sheets of the invention may be prepared with one or more capping layers, and can be prepared by co-extrusion, with a particular technique employing extrusion through a feed block system. Such parameters as the size and loading of immiscible particles in the capping layer, and the thickness of all layers, may vary within the ranges recited herein as within the scope of the invention, to achieve particular effects in the final manufactured products.

The products of the present invention exhibit a combination of improved properties, among them durability and cleanability, and are useful in a variety of applications where a matte or frosted appearance is desirable, among them, for light diffusers and lighting fixtures, privacy panels such as shower doors, retail displays, and projection screens.

### DETAILED DESCRIPTION

For the purposes of the present invention the core layer may consist of a transparent (which is preferred), translucent or opaque first thermoplastic polymer. Suitable examples of the first thermoplastic polymer include polyethylenes, polypropylenes, ethylene-propylene copolymers, ethylene-vinyl acetate copolymers, ethylene-methyl acrylate copolymers, ethylene-ethyl acrylate copolymers, ethylenemethyl methylmethacrylate copolymers, ethylene-vinyl acetate-methyl methacrylate copolymers, polyvinyl chloride, acrylonitrile-styrene copolymers, polystyrenes, styrene-methylmethacrylate copolymers, polyethyl acrylates, polymethyl-methacrylates, methylmethacrylate-methylacrylate copolymers, polyethylene terephthalates, polyamides, polycarbonates, polyurethanes, silicone resins and the like. In the instance where the polymer is an acrylic, the first thermoplastic polymer will typically have a weight average molecular weight of about 100,000 to about 175,000, preferably 125,000 to 150,000.

Preferably, the first thermoplastic polymer comprises a methyl methacrylate-methyl acrylate copolymer wherein the methyl methacrylate is present in the amount of about 80 to about 98 wt. %, preferably 93 to 97 wt. % and the methyl acrylate is present in the amount of about 2 to about 20 wt. %, preferably 3 to 7 wt. %.

At least one capstock layer may be included with the core layer and will overly and will be bonded to at least one face of the core layer. Thus, the plastic sheet product of the invention may have one capstock layer overlying and bonded to one face of the core layer or it may have two capstock layers with each layer overlying and bonded to each face of the core layer.

The capstock layer composition comprises a second thermoplastic polymer containing a plurality of discrete particles immiscible with, and dispersed in, the polymer. The refractive index of the particles will differ from the refractive index of the second thermoplastic polymer. The second thermoplastic polymer may be any of the thermoplastic polymers listed above in respect to the first thermoplastic polymer. The second thermoplastic polymer may be different from the first thermoplastic polymer. In the latter case, the choices of the first and second thermoplastic polymer should be such that they are sufficiently compatible with one another such that the capstock layer will bond to the face of the core layer, and in one embodiment, is able to so bond when the layers are processed by feedblock co-extrusion. In a particular embodiment, the second thermoplastic polymer is the same as the first thermoplastic polymer.

Typically, the core layer will have a thickness of about 2 to 13 mm, and more particularly, a thickness of from about 4 to about 10 mm, and the capstock layer(s) may have a thickness of from about 10 to about 400 microns, and more particularly, from about 150 to about 300 microns.

The particles may be immiscible in the second thermoplastic polymer and will typically be present in the amount of about 4 to about 30 wt. %, preferably 22 to 26 wt. %. The particles may typically have particle size diameters in the range of about 1 micron to about 60 microns, and may preferably be from about 30 to about 50 microns. The particles may comprise a polymer or a pigment. Useful examples of such polymers include crosslinked polymethylmethacrylate, crosslinked polymethylmethacrylate modified with an acrylate or methacrylate monomer, crosslinked copolymers of methylmethacrylate and styrene, silicone resins and polyallyl methacrylates. Useful non-limiting examples of such pigments include barium sulfate, silicon dioxide, aluminum oxide, aluminum hydroxide and calcium carbonate.

The second thermoplastic polymer and the particles will typically have refractive indices in the range of about 1.40 to about 1.65, preferably 1.49 to 1.55. The difference in the refractive index values of the particles and the second thermoplastic polymer will typically be in the range of about 0.001 to about 0.030, preferably 0.005 to 0.020.

The following nonlimiting examples are illustrative of the invention. Unless otherwise indicated, all amounts and percentages are on a weight basis.

### EXAMPLES

### Example 1

In this example, a plastic sheet product containing one capstock layer bonded to the core layer was prepared. The first thermoplastic polymer used for the core layer and the second thermoplastic polymer used for the capstock layer were the same: a copolymer of about 94 wt. % methyl methacrylate and about 6 wt. % methyl acrylate having a melt index of 2.1, a weight average molecular weight of 150,000 and a refractive index of 1.490. The amount of the first thermoplastic composition for the core layer in relation to the second thermoplastic polymer for the capstock layer was such that, after feedblock coextrusion of the two layers, the core layer had a thickness of 5.75 mm and the capstock layer had a thickness of 250 microns. Particles comprising beads of a crosslinked polymethyl methylmethacrylate with a refractive index of 1.488 and average particle diameters of about 40 microns were combined with the second thermoplastic polymer in an amount of 25 wt. % of the beads.

The equipment used to coextrude streams of the core layer composition and the capstock layer composition was a conventional extruder equipped with means to melt and pump the two streams. A conventional combining feedblock combined the streams in molten form as they exited the extruders and thereafter the streams were fed into a conventional single-manifold sheet die and then exited onto conventional multi-roll polishing units cooling racks and pull rolls. In this example, only one capstock layer was bonded to one face of the core layer and therefore, the flow channel on one side of the feedblock was closed off so that the capstock layer could flow to only one side of the core layer.

The equipment was heated to provide a melt temperature of 255° C. and the extrusion process is started. Once the flow is established through the die. the sheet line is strung up in the typical manner with speeds gradually increased to the desired production rate which typically is in the range of 200 to 5,000 pounds per hour.

### Example 2

Example 1 was repeated so as to prepare a plastic sheet product with capstock layers on both faces of the core layer and a total thickness of about 6 mm. Accordingly, the composition of the core layer and the capstock layer were the same as those of Example 1, an the general manufacturing procedure was also the same, with the exception that the flow channels on both sides of the feed block were opened so that the capstock layer composition could flow to both faces of the core layer. The amount of the first thermoplastic composition for the core layer in relation to the second thermoplastic polymers for each capstock layer was such that, after feedblock coextrusion of the three layers was complete, the core layer had a thickness of 5.5 mm and each capstock layer had a thickness of 250 microns.

This invention may be embodied in other forms or carried out in other ways without departing from the spirit or essential characteristics thereof. The present disclosure is therefore to be considered as in all respects illustrative and not restrictive, the scope of the invention being indicated by the appended claims, and all changes which come within the meaning and range of equivalency are intended to be embraced therein.

What is claimed is:

1. A plastic sheet product having a matte finish comprising a core layer of a first thermoplastic polymer and at least one layer of a capstock composition overlying and bonded to at least one face of the core layer, said capstock composition comprising a second thermoplastic polymer having a refractive index and containing a plurality of discrete particles immiscible with, and dispersed in, the second thermoplastic polymer and having a refractive index, wherein the refractive index of the particles differs from the refractive index of the second thermoplastic polymer.

2. The plastic sheet product of claim 1 wherein the first thermoplastic polymer and the second thermoplastic polymer are independently selected from the group consisting of polyethylenes, polypropylenes, ethylene-propylene copolymers, ethylene-vinyl acetate copolymers, ethylene-methyl acrylate copolymers, ethylene-ethyl acrylate copolymers, ethylene-methyl methylmethacrylate copolymers, ethylene-vinyl acetate-methyl methacrylate copolymers, polyvinyl chloride, acrylonitrile-styrene copolymers, polystyrenes, styrene-methylmethacrylate copolymers, polyethyl acrylates, polymethyl-methacrylates, methylmethacrylate-methylacrylate copolymers, polyethylene terephthalates, polyamides, polycarbonates, polyurethanes and silicone resins.

2. The plastic sheet product of claim 1 wherein the first thermoplastic polymer and the second thermoplastic polymer are transparent.

3. The plastic sheet product of claim 1 wherein the second thermoplastic polymer is the same as the first thermoplastic polymer.

4. The plastic product of claim 3 wherein the second and the first thermoplastic polymer comprise a methyl methacrylate-methyl acrylate copolymer.

5. The plastic sheet product of claim 4 wherein the copolymer comprises about 80 to about 98 wt. % methyl methacrylate and about 2 to about 20 wt. % methyl acrylate.

6. The plastic sheet product of claim 5 wherein the copolymer comprises 93 to 97 wt. % methyl methacrylate and 3 to 7 wt. % methyl acrylate.

7. The plastic sheet product of claim 1 wherein the capstock composition is bonded to only one face of the core layer.

8. The plastic sheet product of claim 1 wherein the capstock composition is bonded to both faces of the core layer.

9. The plastic sheet product of claim 1 wherein the first and second thermoplastic polymers have weight average molecular weights in the range of about 100,000 to about 175,000.

10. The plastic sheet product of claim 9 wherein the first and second thermoplastic polymers have weight average molecular weights in the range of 125,000 to 150,000.

11. The plastic sheet product of claim 1 wherein the core layer has a thickness of about 2 to about 13 mm and said at least one capstock layer has a thickness of about 10 to about 400 microns.

12. The plastic sheet product of claim 11 wherein the core layer has a thickness of 4 to 10 mm and said at least one capstock layer has a thickness of 150 to 300 microns.

13. The plastic sheet product of claim 1 wherein the particles have particle size diameters in the range of about 1 micron to about 60 microns.

14. The plastic sheet product of claim 13 wherein the particles have particle size diameters in the range of 30 to 50 microns.

15. The plastic sheet product of claim 1 wherein the particles are dispersed in the second thermoplastic polymer in an amount of about 4 to about 30 wt. %.

16. The plastic sheet product of claim 15 wherein the particles are dispersed in the second thermoplastic polymer in an amount of 22 to 26 wt. %.

17. The plastic sheet product of claim 1 wherein the refractive indices of the particles and the second thermoplastic polymer are in the range of about 1.40 to about 1.65.

18. The plastic sheet product of claim 17 wherein the refractive indices of the particles and the second thermoplastic polymer are in the range of 1.49 to 1.55.

19. The plastic sheet product of claim 1 wherein the refractive index of the particles differs from the refractive index of the second thermoplastic polymer by a value in the range of about 0.001 to about 0.030.

20. The plastic sheet product of claim 19 wherein the refractive index of the particles differs from the refractive index of the second thermoplastic polymer by a value in the range of 0.005 to 0.020.

21. The plastic sheet product of claim 1 wherein the particles are comprised of a polymer or a pigment.

22. The plastic sheet product of claim 21 wherein the particles are comprised of a polymer selected from the group consisting of crosslinked polymethylmethacrylate, crosslinked polymethylmethacrylate modified with an acryl ate or methacryl ate monomer, crosslinked copolymers of methylmethacrylate and styrene, silicone resins and polyallyl methacrylates.

23. The plastic sheet product of claim 21 wherein the pigment is selected from the group consisting of barium sulfate, silicon dioxide, aluminum oxide, aluminum hydroxide and calcium carbonate.

24. The plastic sheet product of claim 1 wherein plastic sheet is formed by feedblock coextrusion of the core layer and the capstock composition.
